(19) United States
(12) Patent Application Publication
(10) Pub. No.: US 2008/0192260 A1
(43) Pub. Date: Aug. 14, 2008

(54) Cascade type interferometric nonlinear optical imaging apparatus

(75) Inventors: Lee Eun Seong, Yuseong-gu (KR); Lee Jae Yong, Cheongju (KR)

Correspondence Address: THE WEBB LAW FIRM, P.C., 700 KOPPERS BUILDING, 436 SEVENTH AVENUE, PITTSBURGH, PA, 15219, US

(73) Assignee: Korea Research Institute of Standards and Science, Yuseong-gu (KR)

(21) Appl. No.: 11/821,913

(22) Filed: Jun. 26, 2007

(30) Foreign Application Priority Data
Feb. 13, 2007 (KR) 10-2007-0015084

(51) Int. Cl. G01B 9/02

(52) U.S. Cl. 356/484

(57) ABSTRACT

The present invention relates to a cascade type interferometric nonlinear optical imaging apparatus, and the imaging apparatus comprises a light source for generating Stokes beam having a desired frequency band and a pump beam for exciting medium molecules in a sample with the Stokes beam; a phase shifting unit for shifting a phase of the beams passing through a standard sample and a phase of an anti-Stokes beam generated from the standard sample on the same path, wherein the Stokes beam and the pump beam generated from the light source pass through the standard sample at the same time to generate the anti-Stokes beam; a scanning unit for scanning the beam phase-shifted by the phase shifting unit onto a space of a test sample; and a detecting unit for detecting optical interference due to a phase difference between a light signal generated by passing the test sample and a light signal generated by passing the standard sample.

### TECHNICAL FIELD

The present invention relates to a cascade type interferometric nonlinear optical imaging apparatus, and more particularly, to a cascade type interferometric nonlinear optical imaging apparatus which performs imaging by using interference of beam passing through a standard sample and a test sample.

### BACKGROUND ART

In most of the conventional optical microscopes, there is a problem that it is difficult to perform imaging which provides clear morphologic images of various intra-cellular organs in transparent bio samples and further distribution images of chemical species. This is caused by that optical contrast is not generated when objects to be observed and background substances interact with light. In other words, certain intra-cellular organs in the samples to be observed are not distinguished from the background substances. Therefore, it is impossible to observe movement of organelles and metabolites in cells using the optical microscope and thus to diagnose life scientific phenomenon and disease mechanism. In order to solve the problem, the samples are dyed with a marker which can radiate fluorescent light and then exposed to ultraviolet ray or laser, so that generated fluorescence can be detected and then studied. That is, researchers can not see the samples as they are, but can see only the samples which are mixed with foreign substances. However, the foreign substances may reduce activity of the bio-samples and thus preclude from obtaining correct information of the movement in the bio-samples. Further, if the fluorescent dye (i.e., foreign substance) is exposed to light for a long time, it has a photobleaching effect. Therefore, there is another problem that it is impossible to perform the imaging.

A Coherent anti-Stokes Raman Scattering (CARS) microscope is an apparatus which can analyze the chemical species in the samples without the fluorescent marker.

The Coherent anti-Stokes Raman Scattering as one of nonlinear optical phenomenons is a basic principle of the microscope, and is four wave mixing in which three incident laser beams interact in the sample and form a single light signal. If two laser beams having a frequency difference which is correspondent to Raman shift of certain molecules in the sample is incident, the molecules are oscillated with forced harmonic motion which is matched with beat Waveforms of the two laser beams.

In other words, all of the certain molecules are oscillated with the same phase. In this situation, if a third laser beam is incident and then Raman-scattered, i.e., anti-Stokes scattered by each molecule, the scattered beams become coherent light having the same phase and direction like a laser. If the interaction between the light and the molecule is occurred in each point of the sample and the signals generated in each point are detected and then mapped in Raster scan method, CARS images for the sample can be obtained.

Nonlinear polarization which determines an intensity of the signal light can be expressed by a below equation. Since the polarization is formed by applying three lights, i.e., three electric fields at the same time, it is called third order nonlinear optical polarization. Herein, XCARS as a proportional coefficient is called third order nonlinear susceptibility. This coefficient shows a resonance property for each molecule, which is a function of wavelength or frequency and has a very large value at specific oscillation frequencies. The reason why the CARS microscope can perform selective molecular imaging is caused by that each molecule has a different third order nonlinear susceptibility. Since the nonlinear light signal is radiated by serving the nonlinear polarization as a dipole, the intensity ICARS of the light signal is expressed by a value which is proportioned to the square of PCARS. Although the light can be radiated by multi-pole modes including a quadrupole, since the light radiated by the multi-pole mode is so faint, it is generally ignored.

$${P}_{CARS} = {χ}_{CARS} {E}_{pump}^{2} {E}_{Stokes}$$

$${χ}_{CARS} = \frac{{ɛ}_{0} N}{8 m [ {ω}_{0}^{2} - {( {ω}_{pump} - {ω}_{Stokes} )}^{2} + i ( {ω}_{pump} - {ω}_{Stokes} ) Γ ]} ( \begin{matrix}{}_{-} \partial a \\ \partial q\end{matrix} )$$

In the CARS microscope, because two pump lights are used as lasers having the same frequency for the convenience' sake, two lasers are substantially used in testing. In this case, a frequency of anti-Stokes Raman scattered light can be indicated by ω_{AS}=2ωₚᵤₘₚ−ω_{Stokes} as shown in FIG. 1. It shows that the photon energy is conserved because an incident photon energy 2 [symbol] ωₚᵤₘₚ+ [symbol] ω_{Stokes} is equal to a photon energy [symbol] ω_{AS}+2 [symbol] ω_{Stokes} radiated after interaction. That is, since it is an optical parametic conversion process that the energy is not remained in a medium even after the interaction, it can be said that the CARS is a real non-invasive method.

There has been proposed spontaneous Raman scattering as a microscopy technique which can perform the selective molecular imaging without fluorescent marker. However, since it is not the coherent process like the CARS, a signal intensity is very weak. In case of the CARS, a signal intensity which is proportioned to the cube of an output of incident light is obtained, and in case of the spontaneous Raman scattering, since it is proportioned linearly, the larger the output of incident light is, the bigger the difference between signal intensities of the two Raman scaterring methods. Even within a relatively low output limitation which does not damage the sample, the CARS has a signal intensity and sensitivity which is about 10,000 times higher than the spontaneous Raman scattering. Therefore, it is possible to observe the living cells through rapid imaging.

As described above, since the signal light which forms an image of the CARS microscope has coherence, signal amplifying techniques using a coherent effect has been proposed in various theses.

FIG. 2 is a view showing an interferometer used in general linear optics.

The interferometer used in the general linear optics has been used in the conventional methods. That is, incident pump light 101 and Stokes light 102 are respectively divided into two pairs by a beam splitter 110 before being radiated onto the sample. One pair is directed to a test sample 170 and the other pair is directed to a standard sample 120. Herein, the standard sample 120 is selected as a solid or liquid homogeneous material which can generate a large local oscillator CARS signal. Each pair of pump light and Stokes light divided and directed to the test sample 170 and the standard sample 120 generates the CARS signal at each sample. Further, the light directed to the standard sample 120 is delayed by a delaying apparatus 130 and then scanned to the test sample by a scanner 160. The two CARS signals are combined by a beam combiner 140 to be interfered. By the interference process, the faint CARS signal obtained from the sample is amplified and detected by a detector 150. Then, a clear CARS image can be obtained by imaging the signal. However, since the beam splitter 110, the beam combiner 140 and a broad band filter 150 and the like are used in this apparatus, there is a problem that the apparatus has a large size and the splitting and combining processes cause incomplete and unstable interference.

### DISCLOSURE OF THE INVENTION

It is an object of the present invention to provide a cascade type interferometric nonlinear optical imaging apparatus which has a small size and simple structure.

It is another object of the present invention to provide a cascade type interferometric nonlinear optical imaging apparatus which can obtain high quality of image through complete and stable interference.

It is yet another object of the present invention to provide a cascade type interferometric nonlinear optical imaging apparatus which can continuously generate signals without beam delay.

The foreging and/or other aspects of the present invention can be achieved by providing a cascade type interferometric nonlinear optical imaging apparatus, comprising a light source for generating Stokes beam having a desired frequency band and pump beam for exciting medium molecules in a sample with the Stokes beam; a phase shifting unit for shifting a phase of the beam passing through a standard sample and a phase of anti-Stokes beam generated from the standard sample on the same path, wherein the Stokes beam and the pump beam generated from the light source pass through the standard sample at the same time; a scanning unit for scanning the beam phase-shifted by the phase shifting unit onto a space of a test sample; and a detecting unit for detecting optical interference due to a phase difference between a light signal generated by passing the test sample and a light signal generated by passing the standard sample.

Preferably, the phase shifting unit has two superimposed glass plates, and an inclined surface is formed on a contact surface of each glass plate, so that the phase of the beams passing through the glass plates can be shifted by regulating an entire thickness of the glass plates.

Preferably, the scanning unit scans the phase-shifted beams onto the sample by using a galvano mirror.

Preferably, the detecting unit is a photomultiplier tube (PMT) or a photodiode (PD) which amplify and detect the anti-Stokes light.

Preferably, the detecting unit is a charge coupled device (CCD) or a high sensitive photodiode array detector which separate a wavelength element of the anti-Stokes light and then detect at the same time.

Further, the imaging apparatus of the present invention is employed in a coherent anti-Stokes Raman microscope.

### BRIEF DESCRIPTION OF THE DRAWINGS

FIG. 1 is a schematic view showing a principle of generating a CARS optical signal;

FIG. 2 is a schematic view showing an imaging apparatus using a conventional linear interferometer;

FIG. 3 is a view showing a cascade type interferometric nonlinear optical imaging apparatus according to the present invention;

FIG. 4 is a view showing an interference pattern obtained by using the cascade type interferometric nonlinear optical imaging apparatus according to the present invention; and

FIG. 5 is a photo obtained by using the cascade type interferometric nonlinear optical imaging apparatus according to the present invention as an imaging apparatus of microscope.

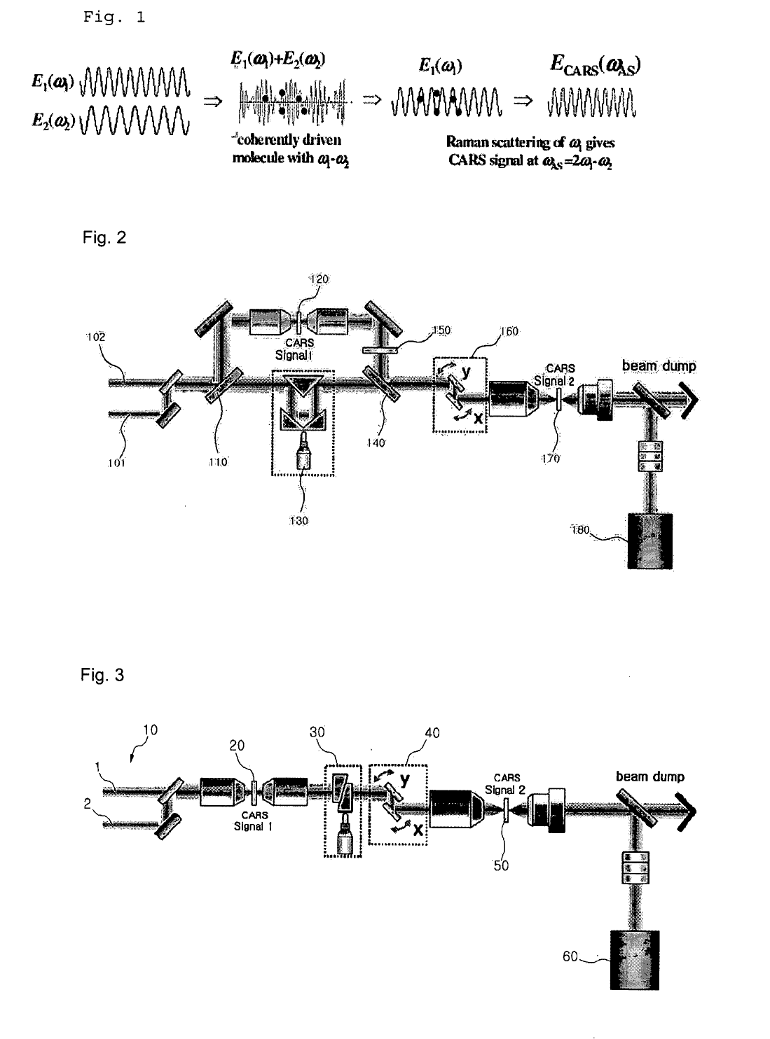

[Detailed Description of Main Elements]

| | |
|---|---|
| 1: Stokes light | 2: pump light |
| 10: light source | 20: standard sample |
| 30: phase shifting unit | 40: scanning unit |
| 50: test sample | 60: detecting unit |

### BEST MODE FOR CARRYING OUT THE INVENTION

Now, the cascade type interferometric nonlinear optical imaging apparatus according to the present invention will be described with reference to the drawings.

FIG. 3 is a view showing a cascade type interferometric nonlinear optical imaging apparatus according to the present invention.

As shown in FIG. 3, the cascade type interferometric nonlinear optical imaging apparatus according to the present invention includes a light source 10 for generating Stokes beam 1 and pump beam 2; a phase shifting unit 30 for shifting a phase of beam generated from the light source 10 and passing through the standard sample 20 and a phase of anti-Stokes beam generated from the standard sample on the same path; a scanning unit 40 for scanning the beam phase-shifted by the phase shifting unit 30 onto a space of a test sample 50; and a detecting unit 60 for detecting optical interference due to a phase difference between the light signal generated by passing the test sample 50 and the light signal generated by passing the standard sample.

The light source 10 generates Stokes beam 1, pump beam 2 and probe beam. Since the pump beam 2 and the probe beam have the same frequency, the pump beam 2 substantially functions as the probe beam.

The pump beam 2 has a fixed frequency, and the Stokes beam 1 can converse its own wavelength within a wide frequency band. While the two beams passes through the standard sample 20, a frequency difference between the two beams is added to the probe beam, thereby generating CARS signal. Thus, the light signal generated from the standard sample 20, i.e., CARS signal 1 generated from the standard sample 20 has a difference of phase velocity, while passing through the phase shifting unit 30 together with the pump beam 2, Stokes beam 1 and the probe beam. Furthermore, since phase relationship among them is changed with respect to a position of the standard sample 20 when they arrive at the test sample 50, the light signal generated from the test sample 50, i.e., CARS signal 2 has a relatively different phase from the CARS signal 1. The phase difference causes the interference.

Unlike the conventional imaging apparatus, the imaging apparatus of the present invention forms a coherent Raman scattering signal at the standard sample and is capable of modulating a phase difference from a second signal generated after passing the test sample, thereby increasing molecular detecting sensitivity in the test sample.

The pump beam 2 and the Stokes beam 1 are frequency-scanned onto the standard sample 20 and the test sample 50 so as to excite the medium molecules of the standard sample 20 and the test sample 50 from ground lever to excited level.

The probe beam, i.e., frequency-scanned beam is anti-Stokes scattered by the excited medium molecules and then the excited molecules are returned to its original state. An amount of medium molecules can be detected by an intensity of the anti-Stokes Raman signal generated at that time.

The phase shifting unit 30 functions to shift the relative phases of the Stokes beam 1 and pump beam 2 generated from the light source 10 and the CARS signal light generated when passing through the standard sample 20. The phase shifting unit 30 has two superimposed glass plates, and an inclined surface is formed on a contact surface of each glass plate. The phase can be shifted by regulating an entire thickness of the glass plates. Since the phase is shifted by using the phase shifting unit 30, it is not necessary to use the beam splitter, the combiner, the beam delay regulator and the broad band filter like in the conventional linear optical interferometer. And it is not necessary to divide and combine the beams and also to regulate the delay time of the beam generated when dividing and combining the beams. Therefore, the entire system can be minimized, and improved quality of images can be obtained due to the complete and stable interference effect.

The scanning unit 40 functions to scan the beams phase-shifted by the phase shifting unit 30 onto the test sample. Preferably, the scanning unit 40 scans the phase-shifted beams onto the sample by using a galvano mirror.

The detecting unit 60 functions to detect optical interference by the phase difference between the CARS signal 1 generated when the beams pass through the standard sample 20 and the CARS signal 2 generated when the beams pass through the test sample 50.

Preferably, the detecting unit 60 is a photomultiplier tube (PMT) or a photodiode (PD) which amplify and detect the anti-Stokes light.

Further, a charge coupled device (CCD) or a high sensitive photodiode array detector which separate a wavelength element of the anti-Stokes light and then detect at the same time may be also used as the detecting unit 60.

As described above, since the cascade type interferometric nonlinear optical imaging apparatus of the present invention employs the nonlinear optical interferometer, only the phase shifting unit 30 is used without the beam splitter, the combiner and the beam delay regulator used in the conventional linear optical interferometer. Therefore, it is not necessary to divide and combine the beams and also to regulate the delay time of the beam generated when dividing and combining the beams. Therefore, the entire system can be minimized, and improved quality of images can be obtained due to the complete and stable interference effect.

Preferably, the cascade type interferometric nonlinear optical imaging apparatus of the present invention is used as an imaging apparatus in the microscope.

According to the present invention, the cascade type nonlinear optical interferometer is firstly employed in the CARS microscope system, thereby constructing simple and stable apparatus.

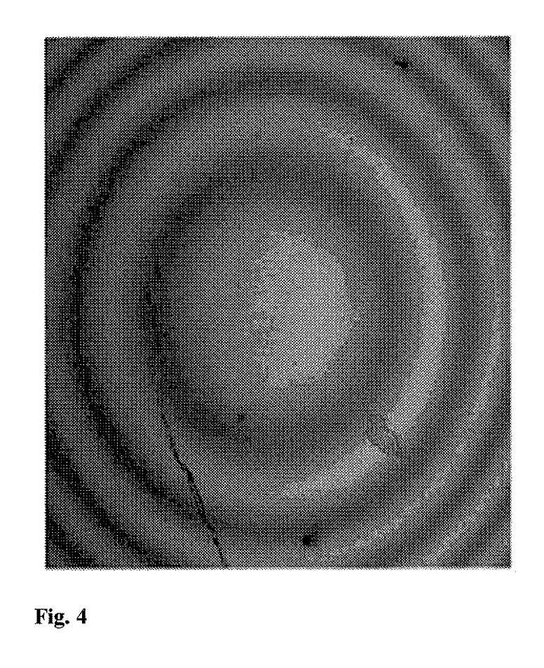

FIG. 4 is a view showing an interference pattern obtained by using the cascade type interferometric nonlinear optical imaging apparatus according to the present invention, which is obtained by detecting the interference of the light signals (CARS signal 1 and CARS signal 2) passing through the standard sample 30 and the test sample 50 in a status that the thickness of the glass plates of the phase shifting unit 30 is fixed. herein, the interference pattern of the two CARS signals is clearly indicated.

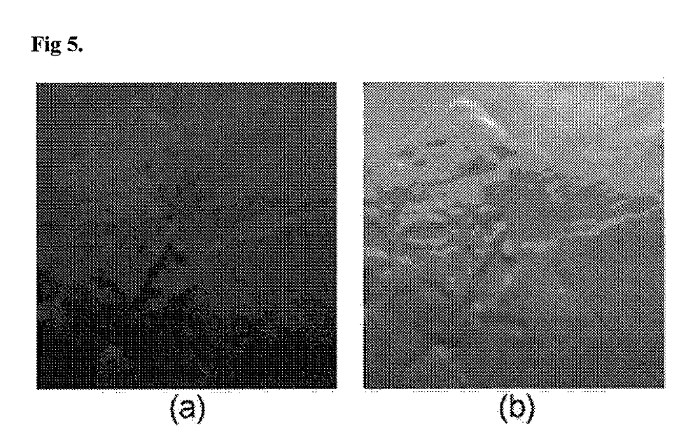

FIG. 5 is a photo obtained by using the cascade type interferometric nonlinear optical imaging apparatus according to the present invention as an imaging apparatus of microscope.

FIG. 5a shows a photo obtained by using the general CARS signal without the interference, and the FIG. 5b shows a photo obtained by using the interference of the CARS signal.

At this time, an output of the light source 10 for generating the pump beam 2 and the Stokes beam 1 is not increased.

As shown in drawings, in comparison with FIGS. 5a and 5b it will be understood that brightness and contrast are improved when using the interference of the CARS signal. According to the present invention as described above, it is possible to obtain the high quality of images using only the interference of the CARS signal without increase in the output of the light source 10.

### INDUSTRIAL APPLICABILITY

Unlike the conventional Raman scattering microscope, the cascade type interferometric nonlinear optical imaging apparatus of the present invention has advantages of increasing the detection sensitivity of medium molecules by exciting the molecules in the standard sample and modulating the phase difference from the beams passing through the test sample. Further, Since the phase is shifted by using the phase shifting unit 30, it is not necessary to use the beam splitter, the combiner, the beam delay regulator and the broad band filter like in the conventional linear optical interferometer. And it is not necessary to divide and combine the beams and also to regulate the delay time of the beam generated when dividing and combining the beams. Therefore, the entire system can be minimized, and improved quality of images can be obtained due to the complete and stable interference effect.

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

1-6. (canceled)

7. A cascade type interferometric nonlinear optical imaging apparatus, comprising:
a light source for generating a Stokes beam having a desired frequency band and a pump beam for exciting medium molecules in a sample with the Stokes beam;
a phase shifting unit for shifting a phase of the beam passing through a standard sample and a phase of an anti-Stokes beam generated from the standard sample on the same path, wherein the Stokes beam and the pump beam generated from the light source pass through the standard sample at the same time;
a scanning unit for scanning the beams phase-shifted by the phase shifting unit onto a space of a test sample; and
a detecting unit for detecting optical interference due to a phase difference between a light signal generated by passing the test sample and a light signal generated by passing the standard sample.

8. The imaging apparatus as set forth in claim 7, wherein the phase shifting unit has two superimposed glass plates, and an inclined surface is formed on a contact surface of each glass plate, so that the phase of the beams passing through the glass plates can be shifted by regulating an entire thickness of the glass plates.

9. The imaging apparatus as set forth in claim 7, wherein the scanning unit scans the phase-shifted beams onto the sample by using a galvano mirror.

10. The imaging apparatus as set forth in claim 7, wherein the detecting unit is a photomultiplier tube (PMT) or a photodiode (PD) which amplify and detect the anti-Stokes light.

11. The imaging apparatus as set forth in claim 7, wherein the detecting unit is a charge coupled device (CCD) or a high sensitive photodiode array detector which separate a wavelength element of the anti-Stokes light and then detect at the same time.

12. The imaging apparatus as set forth in claim 8, wherein the detecting unit is a charge coupled device (CCD) or a high sensitive photodiode array detector which separate a wavelength element of the anti-Stokes light and then detect at the same time.

13. A coherent anti-Stokes Raman microscope using the imaging apparatus as set forth in claim 7.

14. A coherent anti-Stokes Raman microscope using the imaging apparatus as set forth in claim 8.

15. A coherent anti-Stokes Raman microscope using the imaging apparatus as set forth in claim 9.

16. A coherent anti-Stokes Raman microscope using the imaging apparatus as set forth in claim 10.

17. A coherent anti-Stokes Raman microscope using the imaging apparatus as set forth in claim 11.

18. A coherent anti-Stokes Raman microscope using the imaging apparatus as set forth in claim 12.
